(19) United States
(12) Patent Application Publication
(10) Pub. No.: US 2014/0134371 A1
(43) Pub. Date: May 15, 2014

(54) TRANSPARENT POLYAMIDE ELASTOMERS

(71) Applicants: Botho HOFFMANN, Domat/Ems (CH); Heinz HOFF, Tamins (CH)

(72) Inventors: Botho HOFFMANN, Domat/Ems (CH); Heinz HOFF, Tamins (CH)

(73) Assignee: EMS-PATENT AG, Domat/Ems (CH)

(21) Appl. No.: 14/065,187

(22) Filed: Oct. 28, 2013

Related U.S. Application Data
(63) Continuation of application No. 12/670,306, filed on Mar. 17, 2010, now abandoned.

(30) Foreign Application Priority Data
Jul. 25, 2007 (EP) 07 113 101.5

(51) Int. Cl. C08G 69/26; B29C 45/00; B29C 39/00; B29C 47/00

(52) U.S. Cl. CPC C08G 69/26; B29C 47/0004; B29C 45/0001; B29C 39/006
USPC 428/36.9; 528/346; 524/606; 428/36.92; 264/176.1; 264/328.1; 264/255

(57) ABSTRACT

A transparent polyamide elastomer of the general structure (I), where R₁ is a polyamide segment formed from a) 10-100 mol % of alkyl-substituted bis(aminocyclohexyl)methane or bis(aminocyclohexyl)propane and 0-90 mol % of other cycloaliphatic, aliphatic or aromatic C6-C36 diamines, based on the total amount of diamine in the polyamide segment, and b) aliphatic C4-C36 dicarboxylic acids, cycloaliphatic or aromatic C8-C36 dicarboxylic acids, and c) optionally lactams or aminocarboxylic acids C6-C12, R₂ being selected from the group of the divalent radicals: linear or branched C2-C5 polyoxyalkylene, polyolefin, polysiloxane with a number-average molar mass in the range of 200-3000 g/mol, C2-C36 alkylene, C6-C36 cycloalkylene, C6-C20 aryl, polycaprolactone, polyesters based on aliphatic or cycloaliphatic dicarboxylic acids and diols, aliphatic polycarbonate, and also copolymers of or mixtures of these elements, and X₁ and X₂ independently of one another being amide (CONH) or ester (COO) bonds.

### TECHNICAL FIELD

This is a Continuation of U.S. application Ser. No. 12/670,306 filed on Mar. 17, 2010, claiming priority based on International Application No. PCT/CH2008/000318 filed Jul. 17, 2008 which claims priority from European Patent Application No. 07113101.5 filed Jul. 25, 2007, the entire disclosures of which are incorporated herein their entirety.

### FIELD OF THE INVENTION

The present invention relates to a transparent polyamide elastomer having polyamide segments and having a further segment, where this further segment particularly preferably takes the form of an ether segment, ester segment, polyester segment, and/or polyetherester segment, and also applications thereof.

### PRIOR ART

Copolymers made of polyamides and of a further segment, for example taking the form of a diol, polyester, ether, etc. are widely used in industry, in particular in the form of polyesteramides, polyetheresteramides or polyetheramides.

By way of example, some systems of this type will be described by using patent references.

EP 0 163 902 A1 describes a process for the production of polyetheresteramides, using antimony oxide. Polyamide segments mentioned also comprise PACM6 and PACM12, alongside the semicrystalline aliphatic PA systems, e.g. PA12 or PA66.

DE 101 95 908 mixes high-molecular-weight thermo-plastics (polyamides, polyesters, polycarbonates) with specific additives in an extruder, the additives being intended to accelerate the exchange reaction between the polymers. The aim is no more than to produce small concentrations of block copolymers which are intended to function as compatibilizers between very different thermoplastics, so that certain recycling requirements can be satisfied. There is no description of specific production of a polyamide elastomer.

EP 1 783 157 A1 describes a process for the production of polyetheresteramides, requiring the use of a triol alongside the polyetherdiol and the polyamidedi-carboxylic acid. Nothing is said in relation to the transparency of the block copolymers.

Many of the applications here demand that the material has high transparency for light in the visible region.

In this connection, by way of example, EP 0 303 489 A1 describes antistatic molding compositions based on polyetheresteramides, having high transparency and low haze. The ester fraction or polyester fraction used comprises polyetherdiols and specific aromatic diols, alongside one another. In the examples, the polyamide portion is formed exclusively by PA6.

EP 0 221 188 A1 describes polyetheresteramides based on PA6 and on copolymers of tetramethylene glycol and neopentyl glycol, where these are intended to have high transparency. No transmittance values are mentioned, but haze measured on test specimens of thickness 1 mm is below 75%. This very high value and the fact that a polyamide segment which has good crystallization properties was used indicate that high transparency in moldings cannot be achieved by means of these molding compositions.

EP 0 313 861 A1 describes polyetheramides based on various polyamide segments and on polyoxyalkylene-diamines, where these are intended to contain practically no ester bonding systems, and to be transparent. However, no transparency data are given that can be objectively evaluated. The following PA systems are mentioned in the examples: PACMI, BALI, 6I.

DE 24 05 646 C3 describes polyether-polyamide block copolymers composed of MXD6 segments and of polyether segments. The block copolymers are intended inter alia to have high transparency.

US 2005/0165210 A1 moreover describes a polyetheramide block copolymer which contains, in the hard PA block, a monomer which disrupts crystallinity and thus is intended to increase the transparency of moldings. This monomer can, for example, be a cycloaliphatic diamine, e.g. PACM or IPD, or a lactam. The crystalline portion within the polyamide segment amounts to at least 55%, preferably at least 70%, based on the polyamide-forming monomers. Transmittance values stated, measured on plaques of dimensions 100×100×2 mm at 560 nm amount to 77 and 78%. The corresponding haze values are 12 and 13%.

EP 1 314 750 A1 relates to polyetheramides, produced from semicrystalline polyamide segments based on aminocarboxylic acids and/or lactams and on a specific polyetherdiamine (ABA three-block polyetherdiamine). Haze values of from 11 to 46% are stated, measured on plaques of thickness 1 mm. No transmittance values are disclosed.

Last but not least, U.S. Pat. No. 5,280,089 describes a two-stage process for the production of polyetheresteramides, where lactam and polyoxyalkylene glycols are first reacted with one another, and dicarboxylic acid addition and condensation take place only thereafter. Products are described as transparent, but no quantitative information is given.

WO 2007/074086 discloses crosslinkable, thermoplastic polyamide molding compositions. These polyamides have been selected from the group consisting of amorphous or microcrystalline polyamides, of copolyamides of the same and blends thereof, and of blends made of these polyamides with semicrystalline polyamides. A polyamide molding composition of that invention is characterized in that it encompasses a crosslinking additive which on exposure to high-energy radiation, brings about production of moldings molded from said polyamide molding composition, the Tg value of the moldings being >140° C. and their dimensional stability being at least 90% at temperatures >180° C. These polyamides have an essentially linear structure, and their monomers do not have any olefinic C═C double bonds. The disclosure also includes corresponding crosslinked polyamide moldings produced from a polyamide molding composition, and the use of said polyamide molding composition for the production of said crosslinked polyamide moldings. The specifications US 2004/013862, EP 1369447, EP 1712581, and EP 1788025, also describe polyamides of the same general type which have a greater or lesser degree of transparency. Elastomers which could encompass other segments alongside a hard polyamide segment are neither mentioned in nor rendered obvious by these documents.

### SUMMARY OF THE INVENTION

The problem addressed by the invention is therefore inter alia to provide an improved polyamide copolymer or polyamide elastomer. A feature of this is particularly intended to be high transparency. Said problem was solved via a polyamide elastomer which has, as diamine in the polyamide segment, a minimum proportion of 10 mol % of an alkyl-substituted bis(aminocyclohexyl)methane. Specifically, it has been found that a polyamide elastomer or, more generally, a polyamide molding composition made of or having at least a substantial proportion of an elastomer of this type of the general structure

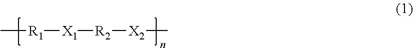

exhibits unexpectedly excellent transparency if R₁ is a polyamide segment, formed from
a) from 10 to 100 mol % of alkyl-substituted bis(aminocyclohexyl)methane and/or bis(aminocyclo-hexyl)propane and
   from 0 to 90 mol % of other cycloaliphatic C6-C36 diamines and/or aliphatic C2-C36 diamines and/or aromatic C6-C36 diamines, (where the concentration data are based on the total amount of diamine in the polyamide segment), and
b) aliphatic C4-C36 dicarboxylic acids and/or cyclo-aliphatic C8-C36 dicarboxylic acids and/or aromatic C8-C36 dicarboxylic acids and
c) if appropriate lactones and/or aminocarboxylic acids C6-C12,
   and R₂ is a soft-segment unit selected from the following group of bivalent moieties: C2-C5-(preferably C2-C4)-polyoxyalkylene, polyolefin, poly-siloxane having a number-average molar mass in the range from 200 to 3000 g/mol (preferably from 300 to 2500 g/mol), linear or branched, substituted or unsubstituted C2-C3-6-alkylene, 6-C36-cycloalkylene, C6-C20-aryl, polycaprolactone, polyester based on aliphatic or cycloaliphatic dicarboxylic acids and diols, aliphatic polycarbonate, and also copolymers or a mixture of these elements,
   and where X₁ and X₂, independently of one another, are amide linkage systems/bonding systems (CONH) or ester linkage systems/bonding systems (COO).

X₁ is normally the same as X₂, but in principle it is also possible that the two elements are different, as by way of example is the case with a simultaneous combination of carboxy-terminated polyamide units with amine-terminated polyether units and hydroxy-terminated polyester or, respectively, ester units. The elastomer is preferably a polyesteramide, a polyetheramide or a polyetheresteramide.

A point that must be emphasized in the interpretation of the structural formula (I) is that, when the term polyamide segment is used for R₁, the polyamide segment R₁ shown on the left-hand side in principle also encompasses the two carbonyl groups arranged on the left- and right-hand side thereof. Another necessary point is that the interpretation of the right-hand portion, normally an amorphous soft segment, within the brackets, requires that, if X₁ and X₂ are (COO) and R₂ is given as C2-C36-alkylene or polyester, the soft segment is, in other words, a C2-C36 alkylenediol or a polyesterdiol, for example the Pripol 2033 or Priplast 3197 materials cited at a later stage in the description (the entire system then being a polyester-amide). By analogy, if X₁ and X₂ are (CONH), and, for example, R₂ is given as C2-C4-polyoxyalkylene, the soft segment can be, in other words, a C2-C4 polyoxy-alkylenediamine, an example being the Elastamin RP-409 material cited at a later stage in the description (the entire system then being a polyetheramide).

One of the essential aspects of the present invention here is that the proposed elastomer structure provides the unexpectedly high-specification combination of transparent material for high-specification optical applications with genuine (i.e. high) flexibility and very good toughness (impact resistance, notched impact resistance). For the purposes of the present invention, high flexibility here normally means a tensile modulus of elasticity in the range from 50 to 1500 MPa, preferably in the range from 100 to 1000 MPa, and particularly preferably in the range from 100 to 500 MPa (the measurement method being given at a later stage below). For the purposes of the invention, very good toughness here is normally the following impact resistance at room temperature and −30° C.: at least 25 kJ/m² or indeed “no fracture”, and/or the following notched impact resistance at RT and −30° C.: at least 15 kJ/m² or at least 25 kJ/m², or indeed “no fracture” (the measurement method being given at a later stage below).

The polyamide elastomers of the invention contain polyamide units and soft-segment units, e.g. polyether units and/or polyester units, and are formed by poly-condensation of the units provided with reactive end groups. The polyamide units here can be either carboxy-terminated or amine-terminated units. As a function of structure, the soft segments are amine-terminated, carboxy-terminated, or hydroxy-terminated units. The preferred soft-segment units are ester units or polyester units, and polyether units. The ester units or polyester units are carboxy- or hydroxy-terminated units, whereas the polyether units bear carboxy end groups or amino end groups. The resultant possible combinations therefore arise for the preferred soft-segment units:
(1) The polyamide unit is carboxy-terminated, and the ester unit or polyester unit is hydroxy-terminated. The resultant copolymer is then a polyesteramide.
(2) The polyamide unit is carboxy-terminated, and the polyether unit is amine-terminated. The resultant copolymer is then a polyetheramide.
(3) The polyamide unit is amine-terminated, and the polyether unit is carboxy-terminated. The resultant copolymer is then a polyetheramide.
(4) The polyamide unit is carboxy-terminated, and the polyether unit is hydroxy-terminated. The resultant copolymer is then a polyetheresteramide.
(5) The polyamide unit is carboxy-terminated, and the polyether unit is amino-terminated, and the polyester unit or ester unit is hydroxy-terminated. The resultant copolymer is a poly-etheresteramide.
(6) The polyamide unit is amine-terminated, and the polyether unit and the polyester unit are carboxy-terminated. The resultant copolymer is a poly-etheresteramide.

It is preferable here that, if both X₁ and X₂ are (COO), the moiety R₂ is defined as linear or branched, substituted or unsubstituted C2-C36-alkylene, C6-C36-cycloalkylene, C6-C20-aryl, polycaprolactone, polyester based on aliphatic or cycloaliphatic dicarboxylic acids and diols, aliphatic polycarbonate, C2-C4-polyoxy-alkylene, or a copolymer or a mixture of these elements.

Another preferred combination here is that if both X₁ and X₂ are (CONH), the moiety R₂ is defined as C2-C4-polyoxyalkylene, polyolefin, polysiloxane with number-average molar mass in the range from 200 to 3000 g/mol (preferably from 300 to 2500 g/mol) or a copolymer or a mixture of these elements.

In one preferred embodiment, at least 20 mol %, preferably at least 30 mol %, particularly preferably at least 40 mol %, of the polyamide segment is based on alkyl-substituted bis(aminocyclohexyl)methane and/or on alkyl-substituted bis(aminocyclohexyl)propane, i.e. the polyamide segment is a copolyamide, or else indeed it is based entirely on alkyl-substituted bis(aminocyclo-hexyl)methane or bis(aminocyclohexyl)propane (homo- or copolyamides). Preferred alkyl substituents are linear and/or branched C1-C6-, preferably C1-C4-alkyl groups, particularly methyl, ethyl, propyl, isopropyl or butyl groups, particularly preferably methyl groups. In one particularly preferred embodiment, MACM (bis(4-amino-3-methylcyclohexyl)methane) is used as alkyl-substituted bis(aminocyclohexyl)methane.

The number-average molar mass of the polyamide segment is preferably adjusted by way of example via an excess of dicarboxylic acid or diamine to from 500 to 5000 g/mol, preferably to from 700 to 4000 g/mol and particularly preferably to from 750 to 3000 g/mol. For regulation of the molar mass, it is preferable to use those dicarboxylic acids or diamines that are also used in the structure of the polyamide segments. However, it is also possible to use the structurally different dicarboxylic acids or diamines described in more detail below.

Monofunctional regulators in the form of monocarboxylic acids or of monoamines can be added to the mixture for the polyamide segment and/or to the mixture for the polyamide elastomer, in addition to the dicarboxylic acids or diamines mentioned, in order to regulate molar mass and relative viscosity or flowability or MVR. Aliphatic, cycloaliphatic or aromatic monocarboxylic acids or monoamines that are suitable as regulators are acetic acid, propionic acid, butyric acid, valeric acid, caproic acid, lauric acid, stearic acid, 2-ethyl-hexanoic acid, cyclohexanoic acid, benzoic acid, butylamine, pentylamine, hexylamine, 2-ethylhexylamine, n-octylamine, n-dodecylamine, n-tetradecylamine, n-hexadecylamine, stearylamine, cyclohexylamine, 3-(cyclohexylamino)propylamine, methylcyclohexylamine, dimethylcyclohexylamine, benzylamine, 2-phenylethyl-amine, etc. The regulators can be used individually or in combination. It is also possible to use, as regulators, other monofunctional compounds which can react with an amino group or with an acid group, examples being anhydrides, isocyanates, acyl halides, or esters. The amount usually used of the regulators is from 10 to 200 mmol per kg of polymer.

In another embodiment, the polyamide elastomer at least has one amorphous phase, preferably deriving from the soft-segment unit, e.g. from the ether fraction and/or ester fraction. In one preferred embodiment, the glass transition temperature of this amorphous phase is at most 20° C. The glass transition temperature of this amorphous phase of the transparent polyesteramides is preferably below 0° C., particularly preferably below −20° C. The glass transition temperature of the soft segment should preferably not be below −70° C., particularly preferably not below −60° C.

The term transparent polyamide elastomer or transparent molding composition, as used in this document, is intended to describe polyamide elastomers or molding compositions formed therefrom which have light transmittance of at least 70% when the polyamide elastomer or the molding composition (in pure form, i.e. without the further constituents cited above for the molding composition of the invention) takes the form of a thin plaque of thickness 2 mm. Light transmittance is measured here in a Perkin Elmer UV/VIS spectrometer in the range from 200 to 800 nm on disks measuring 70×2 mm. The transmittance value is stated for the wavelength range from 500 to 700 nm. The 70×2 mm disks are produced for this purpose by way of example in an Arburg injection-molding machine in a polished mold, the cylinder temperature being from 200 to 340° C. and the mold temperature being from 20 to 140° C.

It is therefore preferable that the transmittance of the polyamide elastomer and/or of the molding composition is at least 70%, preferably at least 80%, particularly preferably greater than 85%.

For components of lower optical specification, or for components in which only the reflection behavior is relevant (for example decorative items), lower transparency and indeed slight haze are also possible.

It is also preferable that the haze of the polyamide elastomer and/or the molding composition is at most 20%, preferably at most 15%, particularly preferably at most 10% (ASTM 1003, layer thickness 2 mm).

In one first preferred embodiment, the polyamide elastomer is characterized in that at least one polyesteramide, polyetheramide, or polyetheresteramide, or the only one of these present, is composed of a polyamide fraction (R₁) making up from 40 to 95% by weight and of a polyester fraction and/or polyether fraction (R₂) making up from 5 to 60% by weight. The polyamide units and polyester units and/or polyether units here can have a random, alternate, or blockwise arrangement as repeat units in the polyamide elastomer. In a second preferred embodiment, the polyamide elastomer is composed of from 5 to 85% by weight of R₁ and from 15 to 50% by weight of R₂. It is preferable that the polyamide elastomer of above structure (1) and of the general composition stated above has an R₂ fraction in the range from 20 to 45% by weight.

However, particular preference is given to polyamide elastomers which contain amorphous or microcrystalline hard polyamide segments. The number-average molar mass of the amorphous or microcrystalline hard polyamide segments of the polyesteramides, polyetheramides, or polyetheresteramides of the invention is in the range from 500 to 5000 g/mol, preferably in the range from 700 to 4000 g/mol and very particularly preferably in the range from 750 to 3000 g/mol.

If a microcrystalline hard polyamide segment or, respectively, hard copolyamide segment is used, it is preferable that the enthalpy of fusion of said hard microcrystalline polyamide segment and/or hard copolyamide segment is in the range from 4 to 40 J/g, in particular in the range from 4 to 25 J/g (measured using differential scanning calorimetry, DSC). It is preferable that the constitutions of microcrystalline hard polyamide/copolyamide segments involve polyamide systems where these, processed in high-molecular-weight form and without further constituents, give transparent moldings. This means that the dimension of the crystallites is below the wavelength of visible light. It is preferable that the glass transition temperature of the microcrystalline hard polyamide segment is above at least 50° C., preferably more than 80° C. and particularly preferably more than 100° C. and, respectively, that its melting point is at least 120° C., preferably at least 135° C. and in particular at least 150° C. As far as the upper limit for these values is concerned, the melting point should preferably not exceed a value of at most 240° C., and the melting point of the hard polyamide segment should be at most 220° C., in particular at most 200° C. The upper limit for the glass transition temperature of the hard polyamide segment should preferably be at most 180° C., with preference at most 150° C., in particular at most 140° C.

The microcrystalline hard polyamide segment and/or microcrystalline hard copolyamide segment is based on alkyl-substituted bis(aminocyclohexyl)methane or bis(aminocyclohexyl)propane and, respectively, if appropriate, on other cycloaliphatic diamines (e.g. PACM, IPD, BAC), and/or on aliphatic C4-C18 diamines and/or diamines having an aromatic ring (e.g. MXDA or PXDA).

It is preferable if the structure uses MACM and aliphatic dicarboxylic acids having from 10 to 36 carbon atoms, the other cycloaliphatic diamine here preferably being PACM and/or IPD (isophoronediamine) having or not having additional substituents, and particularly preferably a copolyamide of MACM/PACM type, in each case with aliphatic dicarboxylic acids having from 10 to 36 carbon atoms, an example being MACM12/PACM12. The PACM concentration here is preferably greater than 40 mol %, particularly greater than 55 mol %.

MACM generally means the compound whose ISO name is bis(4-amino-3-methylcyclohexyl)methane, which is available commercially as 3,3′-dimethyl-4-4′-diamino-dicyclohexylmethane, Laromin C260 (CAS No. 6864-37-5). The numeral after the term MACM always represents an aliphatic linear dicarboxylic acid (C12 meaning, for example, DDS, dodecanedioic acid) with which the diamine MACM has been polymerized.

PACM means the compound whose ISO name is bis(4-aminocyclohexyl)methane, which is available commercially as 4-4′-diaminodicyclohexylmethane, Dicykan (CAS No. 1761-71-3).

As an alternative or in addition, as explained previously, the hard polyamide segment can involve an amorphous polyamide and/or copolyamide, in which case the enthalpy of fusion is preferably less than 4 J/g (measured using differential scanning calorimetry, DSC).

In one preferred embodiment, the glass transition temperature of the amorphous hard polyamide segment is above at least 50° C., preferably more than 80° C. and particularly preferably more than 100° C.

Another preferred embodiment is characterized in that the amorphous hard polyamide segment and/or amorphous hard copolyamide segment is based on MACM, and on aliphatic and/or other cycloaliphatic diamines, preference being given to amorphous polyamides of the following type: MACMI, MACMI/MACMT, MACMI/MACMT/12, MACMI/12, MACMT/12, where the content of laurolactam in this case is preferably smaller than 50 mol %, in particular smaller than 35 mol %. “I” here is isophthalic acid.

In another embodiment, the hard polyamide segment is based on aromatic dicarboxylic acids having from 10 to 18 carbon atoms or aliphatic dicarboxylic acids having from 6 to 36 carbon atoms, or a mixture of these homo-polyamides and/or copolyamides, preferred starting materials here being lactams and/or aminocarboxylic acids, where the aromatic dicarboxylic acids can by way of example be TPA (terephthalic acid) and/or IPA (isophthalic acid). The hard homopolyamide segment and/or hard copolyamide segment can advantageously be a polyamide selected from the following group: 6I/MACMI/MACMT, 6I/6T/MACMI, MACMI/MACM36, lactam-containing polyamides, such as 12/MACMI, 12/MACMT, 12/MACM6-18 or a mixture of these. Other possible systems are: MACM6-18, MACM6-18/PACM6-18, or mixtures formed therefrom.

The polyamides are named as in ISO 1874-1. “I” always means isophthalic acid and “T” always means terephthalic acid.

It is moreover possible and advantageous that the hard copolyamide segment is a polyamide based on at least one dicarboxylic acid and on alkyl-substituted bis(aminocyclohexyl)methane and on a diamine having an aromatic ring, preferably based on MACM and MXD (meta-xylylenediamine), where the dicarboxylic acid can be aromatic and/or aliphatic, preferred examples being MACMI/MXDI, MACMI/MXD6, or MACMI/6I/MXDI, MACMI/6I/MXD6.

Another preferred embodiment is characterized in that the solution viscosity (ηᵣₑₗ) of the polyamide elastomer, measured on a 0.5% by weight solution in m-cresol at a temperature of 20° C. is from 1.3 to 3.0, particularly preferably from 1.4 to 2.5. It is moreover preferable that the tensile modulus of elasticity of the polyamide elastomer is less than 1500 MPa, preferably less than 1000 MPa, particularly preferably less than 500 MPa.

The following structural starting materials are preferred in relation to the polyamide elastomer: transparent polyesteramide, polyetheramide or poly-etheresteramide based on at least one polyamide and based on at least one polyester fraction and/or ester fraction and/or polyether fraction, where the polyamide can be formed from dicarboxylic acids and from alkyl-substituted bis(aminocyclohexyl)methane and, if appropriate, further diamines, and/or from lactams and/or aminocarboxylic acids, and the polyester fraction and/or ester fraction can be formed from a diol and from a dicarboxylic acid and/or from a hydroxycarboxylic acid, and the polyether fraction can be formed from a polyetherdiamine.

Dicarboxylic acid (for both polyamide fraction and for R₂ fraction, i.e., for example, polyester fraction):

The at least one dicarboxylic acid can have been selected from the following group: aliphatic C4-C44 diacid, cycloaliphatic C8-C36 diacid, aromatic diacid (preferably TPA, IPA, NDA), and mixtures or combinations thereof. It is preferable that the at least one dicarboxylic acid has been selected from the following group: adipic acid, sebacic acid, dodecane-dioic acid, terephthalic acid, isophthalic acid, cyclo-hexanedicarboxylic acid and mixtures thereof, and in particular succinic acid, glutaric acid, adipic acid, pimelic acid, suberic acid, azelaic acid, sebacic acid, undecanedioic acid, dodecanedioic acid, brassylic acid, tetradecanedioic acid, pentadecanedioic acid, hexa-decanedioic acid, heptadecanedioic acid, octadecane-dioic acid, nonadecanedioic acid, eicosanedioic acid, japanic acid, cyclohexanedicarboxylic acid, particularly cis- and/or trans-cyclohexane-1,4-di-carboxylic acid and/or cis- and/or trans-cyclohexane-1,3-dicarboxylic acid (CHDA), dimer fatty acid having 36 or 44 carbon atoms, isophthalic acid, terephthalic acid, naphthalenedicarboxylic acid.

### Diamine (for Polyamide Fraction):

Diamine selected from the following group: branched or unbranched aliphatic C4-C18 diamine, cycloaliphatic C8-C20 diamine, diamine having an aromatic ring, and mixtures and, respectively, combinations thereof. Examples of linear or branched, aliphatic diamines are 1,4-butanediamine, 1,5-pentanediamine, 2-methyl-1,5-pentanediamine (MPMD), 1,6-hexanediamine, 1,7-heptanediamine, 1,8-octanediamine (OMDA), 1,9-nonanediamine (NMDA), 2-methyl-1,8-octanediamine (MODA), 2,2,4-trimethylhexamethylenediamine (TMHMD), 2,4,4-trimethylhexamethylenediamine (TMHMD), 5-methyl-1,9-nonanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine, and 1,18-octadecanediamine. Examples of cycloaliphatic diamines that can be used are cyclohexanediamine, 1,3-bis(aminomethyl)cyclohexane (BAC), isophoronediamine, norbornanediamine, norbornanedimethylamine, bis(aminomethyl)norbornane, 4,4′-diaminodicyclohexylmethane (PACM), 2,2-(4,4′-diaminodicyclohexyl)propane (PACP) and 3,3′-dimethyl-4,4′-diaminodicyclohexylmethane (MACM). Araliphatic diamines that may be mentioned are m-xylylenediamine (MXDA) and p-xylylenediamine (PXDA). Preferred other diamines alongside MACM are: 2-methyl-1,5-pentanediamine, 1,6-hexanediamine, trimethylhexa-methylenediamine, methyloctanediamine, nonanediamine, decanediamine, dodecanediamine, m- and/or p-xylylene-diamine, PACM, norbornanediamine and 1,3-bis(amino-methyl)cyclohexane.

### Lactam or Aminocarboxylic Acid (Constituent (c)):

Lactam or aminocarboxylic acid selected from the following group: caprolactam, laurolactam, aminocaproic acid, aminolauric acid, aminoundecanoic acid.

Specifically preferred lactams are lactams and, respectively, amino acids of the α,ω class having 4, 6, 7, 8, 11, or 12 carbon atoms. These are the following lactams: pyrrolidin-2-one (4 carbon atoms), ε-capro-lactam (6 carbon atoms), enantholactam (7 carbon atoms), caprylolactam (8 carbon atoms), laurolactam (12 carbon atoms) and, respectively, the following amino acids of the α,ω class: 4-amino-1-butanoic acid, 6-amino-1-hexanoic acid, 7-amino-1-heptanoic acid, 8-amino-1-octanoic acid, 11-amino-1-undecanoic acid and 12-amino-1-dodecanoic acid.

### Diol (Provision of R₂):

Diols selected from the following group: aliphatic C2-C36 diol, cycloaliphatic C6-C36 diol, C8-C36 diol having an aromatic ring, diol containing ether groups, polycaprolactonediol, or a combination thereof. It is preferable that the diol is selected from the following group: ethanediol, propanediol, butanediol, pentanediol, hexanediol, neopentyl glycol, cyclohexane-dimethanol, C36 dimer fatty diol, polyoxyalkylenediols (linear or branched C2-C5-alkylene moieties) (particularly with a molar mass in the range from 200 to 2000 g/mol), polycaprolactonediol with a molar mass in the range from 500 to 3000 g/mol (particularly preferably from 750 to 2000 g/mol), and combinations thereof.

Polyether segment (amino- or carboxy-terminated, provision of R₂)

Polyoxyethylenediamine, polyoxyethylenedicarboxylic acid, polyoxypropylenediamine, polyoxypropylenedi-carboxylic acid, polyoxytetramethylenediamine, polyoxy-tetramethylenedicarboxylic acid with a number-average molar mass in the range from 200 to 2500 g/mol, copolymers thereof or a mixture, and copolymers with the diols listed above.

As mentioned previously, the transparent polyamide elastomer is preferably a polyetheramide or polyether-esteramide or polyesteramide, particularly preferably based on a polyamide system selected from the following group: MACM12, MACM18, MACM12/PACM12, MACM18/PACM18, copolyamides using 6,T, 9,T, 10,T, and/or 12,T units, or a mixture and/or combination thereof.

Preferred Polyester Fraction and/or Ester Fraction:

The transparent polyamide elastomer is preferably a polyesteramide or a polyetherester based on a polyester fraction and/or ester fraction using a polyester made of a C36 diol and/or adipic acid and/or sebacic acid and/or C36 dimer fatty acid and/or terephthalic acid.

The polyamide elastomers are produced in a one- or two-stage polycondensation process. In the one-stage process, the components forming polyamide are mixed together with the ester or polyester component and/or the polyether component using, as far as possible, an equimolar ratio of the end groups of the individual components, and polycondensed at temperatures in the range from 180 to 300° C. until the desired viscosity has been reached. If a specific block-type structure is desired, particularly in relation to the polyamide unit, or if concomitant use is made of lactams as raw material, the two-stage process is advantageously used. In a first stage of this process, the polyamide units provided with carboxy end groups or with amino end groups are formed at temperatures of from 180 to 320° C. and at pressures of from 10 to 20 bar from components a), b) and c), and these are then polycondensed with the soft-segment units at atmospheric pressure or reduced pressure (in vacuo) at temperatures in the range from 180 to 280° C. to give the high-molecular-weight copolymer. If soft-segment units having hydroxy end groups are used, it is advantageous to use esterification catalysts, e.g. organic titanates or zirconates, to accelerate the reaction.

The invention further provides articles made of this type of polyamide elastomer and, respectively, of a molding composition comprising the same at least as substantial constituent, and also provides a corresponding semifinished product, for example pellets, etc. It therefore by way of example also provides a transparent (the definition of transparent being as stated above), preferably haze-free article with at least one region or one layer made of the polyamide elastomer described above.

In other words, this article preferably has, when the thickness of the layer made of the polyamide elastomers is 2 mm, transmittance of more than 70%, with preference more than 85%, in the wavelength range from 500 to 700 nm, and/or haze of at most 20%, with preference at most 15%, particularly preferably at most 10%.

Various embodiments of the article can be a foil, a profile, a tube, a hollow body or an optically variable filter or an optical lens, preferably an ophthalmic lens, particularly preferably, given additional presence of a dye, for example a photochromic dye, an element with spectral filter action, for example taking the form of a spectacle lens, sun lens, corrective lens, or optical filter, or can take the form of a switching assembly for optical signal processing, ski goggles, a visor, safety spectacles, a photo recording system, display, optical data storage system, or windows of buildings or of vehicles, or can take the form of a decorative element or a structural element, for example in the form of a spectacle frame, toy, or cover, particularly in the form of a mobile-telephone case, a part of electronic devices, a coating, particularly of packaging, of decorative items, of sports equipment, or of cladding, preferably in the automobile sector.

The present invention also provides a process for the production of this article. It is preferably characterized in that the polyamide elastomer described above is molded in an extrusion process, in an injection-molding process or in an in-mold-coating process.

The dependent claims describe other preferred embodiments.

### METHODS OF WORKING THE INVENTION

A number of examples will be used below to illustrate the invention. The examples are intended to indicate how a polyamide elastomer and, respectively, a molding composition formed therefrom can be produced and, for example, processed to give a molding, but they should not be interpreted as restricting the protected subject matter defined in the attached claims.

The following were synthesized: six examples of the invention (termed IE1-IE6) and one comparative example (termed CE1) in the form of a polyetheramide without any content of alkyl-substituted bis(aminocyclo-hexyl)methane and/or bis(aminocyclohexyl)propane, and the properties of the materials from these were then measured and compared with one another. In order to improve comparison with the prior art, the following were also subjected to measurement and included in the analysis: comparative examples (CE2 and CE3) in the form of straight MACM12 and PACM12. This in particular showed that the flexibility and toughness of said materials are very inadequate for many applications of the invention.

The table below collates constitution and resultant properties of the materials:

TABLE
Inventive examples 1 to 6 (IE1-IE6) and comparative examples 1 to 3 (CE1-CE3)

| | | Inventive examples/Comparative examples | | | | | | | | |
|---|---|---|---|---|---|---|---|---|---|---|
| | Unit | IE1 | IE2 | IE3 | IE4 | IE5 | IE6 | CE1 | CE2 | CE3 |
| Constitution | | | | | | | | | | |
| Laurolactam | % by wt. | 0.0 | 0.0 | 0.0 | 0.0 | 0.0 | 0.0 | 39.0 | 0.0 | 0.0 |
| C36 dimer acid | % by wt. | 0.0 | 0.0 | 0.0 | 0.0 | 0.0 | 0.0 | 14.0 | 0.0 | 0.0 |
| DDA | % by wt. | 37.0 | 39.9 | 37.7 | 44.7 | 43.7 | 45.9 | 0.0 | 49.1 | 52.2 |
| MACM | % by wt. | 24.5 | 30.8 | 21.3 | 29.6 | 24.7 | 34.4 | 0.0 | 50.9 | 0.0 |
| PACM | % by wt. | 0.0 | 0.0 | 0.0 | 0.0 | 0.0 | 0.0 | 0.0 | 0.0 | 47.8 |
| Pripol 2033 | % by wt. | 29.2 | 22.2 | 40.9 | 0.0 | 0.0 | 0.0 | 0.0 | 0.0 | 0.0 |
| Priplast 3197 | % by wt. | 9.2 | 7.0 | 0.0 | 0.0 | 0.0 | 0.0 | 0.0 | 0.0 | 0.0 |
| Tyzor NPZ | % by wt. | 0.1 | 0.1 | 0.1 | 0.0 | 0.0 | 0.0 | 0.0 | 0.0 | 0.0 |
| Elastamine RP-2009 | % by wt. | 0.0 | 0.0 | 0.0 | 0.0 | 0.0 | 0.0 | 47.0 | 0.0 | 0.0 |
| Elastamine RP-409 | % by wt. | 0.0 | 0.0 | 0.0 | 25.7 | 31.6 | 18.7 | 0.0 | 0.0 | 0.0 |
| Properties | | | | | | | | | | |
| Number-average molar mass | g/mol | 1000 | 1500 | 750 | 1000 | 750 | 1500 | 2100 | 16 700 | 19 300 |
| (theoret.), PA segment | | | | | | | | | | |
| Rel. viscosity | | 1.43 | 1.49 | 1.37 | 1.41 | 1.46 | 1.48 | 1.68 | 1.74 | 1.90 |
| COOH | mmol/kg | 5 | 34 | 10 | 80 | 90 | 93 | 2 | 35 | 51 |
| NH₂ | mmol/kg | 11 | 11 | 5 | 10 | 12 | 14 | 60 | 54 | 53 |
| Tg (hard PA segment) | ° C. | 75 | 85 | 83 | 82 | 78 | 92 | 26 | 154 | 140 |
| Tg (soft segment) | ° C. | −25 | −25 | −27 | −33 | −35 | −35 | −38 | nss | nss |
| Tm | ° C. | 194 | 202 | 195 | 190 | 173 | 206 | 162 | n.m. | 250 |
| Hm | J/g | 6 | 13 | 9 | 13 | 8 | 15 | 30 | n.m. | 42 |
| Tensile modulus of elasticity | MPa | 230 | 240 | 100 | 950 | 120 | 1300 | 90 | 1520 | 1500 |
| Ultimate tensile strength | MPa | 23 | 25 | 24 | 29 | 28 | 34 | 15 | 45 | 80 |
| Tensile strain at break | % | 280 | 280 | 400 | 250 | 330 | 130 | 600 | 120 | 40 |
| Impact resistance, 23° C. | kJ/m² | n.f. | n.f. | n.f. | n.f. | n.f. | 25 | n.f. | n.f. | n.f. |
| Impact resistance, −30° C. | kJ/m² | n.f. | n.f. | n.f. | n.f. | n.f. | 50 | n.f. | n.f. | n.f. |
| Notched impact resistance, 23° C. | kJ/m² | n.f. | n.f. | n.f. | n.f. | n.f. | 8 | n.f. | 12 | 14 |
| Notched impact resistance, −30° C. | kJ/m² | 40 | 39 | 90 | 75 | 80 | 1.6 | n.f. | 12 | 13 |
| Transmittance at 600 nm | % | 85 | 88 | 85 | 82 | 84 | 81 | 79 | 93 | 93 |
| Haze | % | 3.4 | 2.4 | 2.6 | 5.1 | 8.6 | 4.5 | 4.5 | 1.2 | 1.5 |

n.f. = no fracture; n.m. = not measurable; nss = no soft segment present

The materials used here are as follows:

| | |
|---|---|
| DDA | dodecanedioic acid |
| MACM | bis(4-amino-3-methylcyclohexyl)methane |
| PACM | Bis(4-aminocyclohexyl)methane |
| Pripol 2033 | is a C36 diol (CAS No. 147853-32-5), |
| | obtainable from Uniqema |
| Priplast 3197 | is a dimer diol dimerate (CAS No. 177591- |
| | 08-1), produced from dimer diol, e.g. |
| | Pripol 2033, and from C36 dimer fatty |
| | acid, obtainable from Uniqema |
| Tyzor NPZ | tetra(n-propyl) zirconate, obtainable |
| | from DuPont |
| Elastamine RP | -409 is a polyoxypropylenediamine with |
| | molar mass about 440 g/mol, obtainable |
| | from Huntsman. |
| Elastamine RP | -2009 is a polyoxypropylenediamine with |
| | molar mass about 1980 g/mol, obtainable |
| | from Huntsman |

The starting materials were produced as follows, using an initial charge of the materials stated above in a stirred tank:

In a first stage, the hard polyamide segment is polycondensed. For this, the initial charge of the polyamide-forming monomers (MACM, dodecanedioic acid, etc.) and antifoam is introduced into the reactor and inertized with nitrogen. The reactor is then heated to 270° C. and the reaction mixture is stirred at product temperature 260° C. for 4 hours, under a blanket of nitrogen (barometric degassing).

In the case of inventive examples IE1 to IE3, the carboxy-terminated hard polyamide segments were reacted in a second stage with diols and/or hydroxy-terminated polyesters. For this, a mixture composed of diol, polyester and esterification catalyst was added to the melt of the hard polyamide segment (temperature: from 230 to 260° C.)

In the case of inventive examples IE4 to IE6, the carboxy-terminated hard polyamide segment was reacted in a second stage with the polyetherdiamine. For this, the polyetherdiamine preheated to 1.0° C., is added, if appropriate together with stabilizers and condensation accelerators, to the melt of the hard polyamide segment, the temperature of which is from 230 to 260° C.

The pressure in the reactor is then reduced to 200 mbar within a period of 60 minutes. The reaction mixture is stirred at this pressure for 30 minutes, and then the pressure is lowered within a period of 60 minutes down to a final pressure which is smaller than 20 mbar. As soon as the desired torque is achieved, the vacuum is broken, and nitrogen at 5 bar is applied to the polymer melt, which is discharged through nozzles into a water bath. The strands discharged are pelletized, and the pellets are dried at 80° C. for 24 h. The properties listed in the table were determined in the dry state.

The number-average molar mass of the polyamide segments was determined from the following equation:

$${m}_{R} = \frac{( m - {m}_{{H}_{2} O} ) * {M}_{R}}{{M}_{n} - {M}_{R}}$$

$${M}_{n} = \frac{( m - {m}_{{H}_{2} O} ) * {M}_{R}}{{m}_{R}} + {M}_{R}$$

m_{R}=amount of regulator in g
m=amount of polyamide-forming monomers in g
m_{H2O}=amount of water produced in g
M_{R}=molar mass of regulator in g/mol
Mₙ=theoretical block length in g/mol

Relative viscosity (ηᵣₑₗ) was determined to DIN EN ISO 307, in 0.5% strength by weight m-cresol solution at a temperature of 20° C.

Glass transition temperature (Tg), melting point (Tm) and enthalpy of fusion (Hm) were determined to ISO 11357-1/2. The heating rate used in differential scanning calorimetry (DSC) was 20K/min.

Haze and transmittance were determined on 70×2 mm disks at 23° C., using a Haze-Gard Plus from Byk-Gardner to ASTM D1003 (illuminant C).

Tensile modulus of elasticity was determined to ISO 527, using a tensile testing speed of 1 mm/min, and ultimate tensile strength and tensile strain at break were determined to ISO 527, using a tensile testing speed of 50 mm/min, at a temperature of 23° C., using an ISO tensile specimen, standard: ISO/CD 3167, type A1, 170×20/10×4 mm.

Impact resistance and notched impact resistance (Charpy) were determined to ISO 179 on an ISO test specimen, standard: ISO/CD 3167, type B1, 80×10×4 mm, at a temperature of 23° C.

Amino end group concentrations and carboxy end group concentrations are determined by means of potentio-metric titration. For the amino end groups here, from 0.2 to 1.0 g of polyamide or polyamide oligomer are dissolved in a mixture made of 50 ml of m-cresol and 25 ml of isopropanol, at from 50 to 90° C., and titrated with a 0.05 molar perchloric acid solution after addition of aminocaproic acid. To determine the COOH end groups, from 0.2 to 1.0 g of the specimen to be determined are dissolved, as a function of solubility, in benzyl alcohol or in a mixture made of o-cresol and benzyl alcohol at 100° C., and titrated with a 0.1 molar tetra-n-butylammonium hydroxide solution after addition of benzoic acid.

What is claimed is:

1. A transparent polyamide elastomer of the following structure 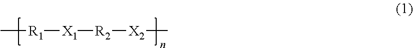
where n represents the number of repeating units in the elastomer, and where R₁ is a microcrystalline hard polyamide segment, or, respectively, hard copolyamide segment, with an enthalpy of fusion in the range from 4 to 40 J/g, and with a melting point of at least 120° C., wherein the number-average molar mass of R₁ is in the range from 750 to 3000 g/mol and wherein R₁ is a polyamide segment, formed from
a) from 10 to 100 mol % of alkyl-substituted bis(aminocyclohexyl)methane and/or bis(aminocyclo-hexyl)propane and
from 0 to 90 mol % of other cycloaliphatic C6-C36 diamines and/or aliphatic C2-C36 diamines and/or aromatic C6-C36 diamines,
where these concentration values are based on the total amount of diamine in the polyamide segment, and
b) aliphatic C4-C36 dicarboxylic acids and/or cyclo-aliphatic C8-C36 dicarboxylic acids and/or aromatic C8-C36 dicarboxylic acids and
c) if appropriate lactones and/or aminocarboxylic acids C6-C12,
where R₂ is selected on the basis of a diol selected from the following group: aliphatic C2-C36 diol, cycloaliphatic C6-C36 diol, C8-C36 diol having an aromatic ring, diol containing ether groups, polycaprolactonediol, or a combination thereof,
wherein R₁ accounts for an amount in the range from 55-80% by weight and R₂ accounts for an amount in the range of 20-45% by weight,
where X1 and X2 are ester bonding systems (COO), and
wherein the transparent polyamide elastomer has an amorphous phase deriving from the segment containing the element R₂, where the glass transition temperature of this phase is at most 20° C.

2. The polyamide elastomer as claimed in claim 1 or 33, wherein at least 20 mol % of the polyamide segment R₁ is based on alkyl-substituted bis(aminocyclohexyl)methane.

3. The polyamide elastomer as claimed in claim 1 or 33, wherein the polyamide segment R₁ is based entirely on alkyl-substituted bis(aminocyclohexyl)methane.

4. The polyamide elastomer as claimed in claim 1 or 33, wherein the alkyl-substituted bis(aminocyclohexyl)methane is bis(4-amino-3-methyl cyclohexyl)methane (MACM).

5. The polyamide elastomer as claimed in claim 1 or 33, wherein the number-average molar weight of the polyamide segment R₁ is in the range from 500 to 5000 g/mol.

6. The polyamide elastomer as claimed in claim 1 or 33, with a transmittance of at least 70%.

7. The polyamide elastomer as claimed in claim 1 or 33, with a haze of at most 20%.

8. The polyamide elastomer as claimed in claim 1 or 33, wherein the polyamide segment R₁ and the segment containing the element R₂ have a statistical, alternating or blockwise arrangement.

9. The polyamide elastomer as claimed in claim 1 or 33, where the polyamide segment (R₁) is a microcrystalline hard polyamide segment or, respectively, hard copolyamide segment, with enthalpy of fusion in the range from 4 to 40 J/g and/or with a glass transition temperature above at least 50° C. and/or with a melting point of at least 120° C.

10. The polyamide elastomer as claimed in claim 1 or 33, wherein R₁ is composed of bis(4-amino-3-methylcyclohexyl)methane (MACM) and of at least one aliphatic dicarboxylic acid having from 10 to 36 carbon atoms, and where the additional other cycloaliphatic diamine present is bis(4-aminocyclo-hexyl)methane (PACM) and/or isophoronediamine (IPD), having or not having substitution.

11. The polyamide elastomer as claimed in claim 1 or 33, wherein R₁ is composed of bis(4-amino-3-methylcyclohexyl)methane (MACM) and bis(4-aminocyclohexyl)methane (PACM) in combination with an aliphatic dicarboxylic acid having from 10 to 36 carbon atoms, where the concentration of bis(4-aminocyclohexyl)methane (PACM) is greater than 40 mol %.

12. The polyamide elastomer as claimed in claim 1 or 33, wherein the polyamide segment R₁ is an amorphous hard polyamide segment or, respectively, hard copolyamide segment, with enthalpy of fusion in the range below 4 J/g, and/or with a glass transition temperature of at least 50° C.

13. The polyamide elastomer as claimed in claim 12, wherein the polyamide segment R₁ is based on bis(4-amino-3-methylcyclohexyl)methane (MACM) and isophthalic acid and/or terephthalic acid and/or on an aliphatic C4-C36 dicarboxylic acid and/or on a cycloaliphatic C8-C36 dicarboxylic acid.

14. The polyamide elastomer as claimed in claim 12, wherein the polyamide segment R₁ is MACMI, MACMI/MACMT, MACMI/MACMT/12, MACMI/12, MACMT/12, where the content of laurolactam is smaller than 50 mol %.

15. The polyamide elastomer as claimed in claim 1 or 33, wherein the polyamide segment R₁ is a hard polyamide segment based on aromatic dicarboxylic acids having from 10 to 18 carbon atoms and/or on aliphatic dicarboxylic acids having from 6 to 36 carbon atoms, or is a mixture of such homopolyamides and/or copolyamides.

16. The polyamide elastomer as claimed in claim 1 or 33, wherein the polyamide segment R₁ is a hard copolyamide segment based on at least one dicarboxylic acid and on alkyl-substituted bis(aminocyclohexyl)methane and on a diamine having an aromatic ring, based on MACM and MXD, where the dicarboxylic acid is aromatic and/or aliphatic.

17. The polyamide elastomer as claimed in claim 1 or 33, wherein its solution viscosity (nᵣₑₗ), measured in m-cresol in the form of 0.5% strength by weight solution, at a temperature of 20° C., is from 1.3 to 3.0 and/or its tensile modulus of elasticity is less than 1500 MPa.

18. The polyamide elastomer as claimed in claim 1 or 33, wherein the dicarboxylic acids of polyamide segment R₁ and/or R₂ are selected from the following group: aliphatic C4-C44 diacid, cycloaliphatic C8-C36 diacid, aromatic diacid, TPA, IPA, NDA, and also mixtures and, respectively, combinations thereof.

19. The polyamide elastomer as claimed in claim 1 or 33, wherein the other diamine of the polyamide segment is selected from the following group: branched or unbranched aliphatic C4-C18 diamine, cycloaliphatic C8-C20 diamine, MXDA, PXDA, methyl-pentanediamine, hexanediamine, trimethylhexamethylene-diamine, methyloctanediamine, nonanediamine, decane-diamine, dodecanediamine, PACM, norbornanediamine, 1,3-bis(aminomethyl)cyclohexane, and also mixtures and, respectively, combinations thereof.

20. The polyamide elastomer as claimed in claim 1 or 33, wherein component (c) is selected from the following group: caprolactam, laurolactam, aminocaproic acid, aminolauric acid, aminoundecanoic acid, amino acids of the α,ω class having 4, 6, 7, 8, 11 or 12 carbon atoms.

21. The polyamide elastomer as claimed in claim 1 or 33, wherein R₂ has been provided on the basis of a diol selected from the following group: hexandiol, cyclohexanedimethanol, C36 dimer fatty diol, and also copolymers or a mixture of these elements.

22. The polyamide elastomer as claimed in claim 1 or 33, wherein it is a polyetheramide, a polyesteramide, or a polyetherester-amide, based on a polyamide system selected from the following group: MACM12, MACM18, MACM12/PACM12, MACM18/PACM18, copolyamides involving 6T, 9T, 10T, and/or 12T units, and, respectively, mixtures and/or combinations thereof.

23. The polyamide elastomer as claimed in claim 1 or 33, wherein it is a poly-etheramide, a polyesteramide, or a polyetheresteramide, having a polyester fraction and/or, respectively, ester fraction derived from a C36 diol and/or adipic acid and/or sebacic acid and/or C36 dimer fatty acid and/or terephthalic acid.

24. The polyamide elastomer as claimed in claim 1 or 33, wherein it also comprises dyes and/or additives, where the dye is a photochromic dye which is reversibly excitable by UV or short-wave VIS, and/or where the additives are stabilizers, such as UV stabilizers, heat stabilizers, free-radical scavengers, and/or are processing aids, plasticizers, or further polymers, and/or are functional additives or are a combination or mixture thereof.

25. A transparent, essentially haze-free article with at least one region or one layer made of a polyamide elastomer as claimed in claim 1 or 33.

26. The article as claimed in claim 25 for high-specification optical applications, wherein, if the thickness of the layer made of the polyamide elastomers is 2 mm, the transmittance of the article is more than 70% in the wavelength range from 500 to 700 mm, and/or the haze of the article is at most 20%.

27. The article as claimed in claim 25, wherein it is a foil, a profile, a tube, a hollow body or an optically variable filter or an optical lens, or a decorative element or a structural element.

28. A process for the production of an article as claimed in claim 25, wherein a polyamide elastomer as claimed in claim 1 is molded in an extrusion process, in an injection-molding process or in an in-mold-coating process, to give the article.

29. A process for the production of a polyamide elastomer as claimed in claim 1 or 33, wherein, in a single-stage process, the polyamide-forming components are mixed together with the ester component or polyester component and/or polyether component, where the ratio of the end groups of the individual components is equimolar, and are polycondensed at temperatures which are in the range from 180 to 300° C. until the desired viscosity has been reached.

30. A process for the production of a polyamide elastomer as claimed in claim 1 or 33, wherein, in particular for a specifically blockwise structure, particularly in relation to the polyamide unit, or in the event of the use of lactams as raw material, in a two-stage process, a first stage begins by forming the polyamide units provided with carboxy or amino end groups, from components a), b) and c) at temperatures which are from 180 to 320° C. and at pressures which are from 0 to 20 bar, and then these are polycondensed in the second stage with the soft-segment units at atmospheric pressure or reduced pressure, at temperatures which are in the range from 180 to 280° C., to give the high-molecular-weight copolymer.

31. The polyamide elastomer as claimed in claim 1, wherein the polyamide segment R₁ is a hard polyamide segment based on aromatic dicarboxylic acids wherein it is a polyamide selected from the following group: 6I/MACMI/MACMT, 6I/6T/MACMI, MACMI/MACM36, MACM6-18, MACM6-18/PACM6-18, 12/MACMI, 12/MACMT, 12/MACM6-18 or a mixture thereof.

32. The polyamide elastomer as claimed in claim 1, wherein the dicarboxylic acids of polyamide segment R₁ and/or R₂ are selected from the following group: aliphatic C4-C44 diacid, cycloaliphatic C8-C36 diacid, aromatic diacid, TPA, IPA, NDA, and also mixtures and, respectively, combinations thereof, having been selected from the following group: adipic acid, sebacic acid, dodecanedioic acid, terephthalic acid, isophthalic acid, cyclohexanedicarboxylic acid and mixtures thereof, succinic acid, glutaric acid, adipic acid, pimelic acid, suberic acid, azelaic acid, sebacic acid, undecanedioic acid, dodecanedioic acid, brassylic acid, tetradecanedioic acid, pentadecanedioic acid, hexadecanedioic acid, heptadecanedioic acid, octadecanedioic acid, nonadecanedioic acid, eicosane-dioic acid, japanic acid, cyclohexanedicarboxylic acid, dimer fatty acid having or 44 carbon atoms, isophthalic acid, terephthalic acid, naphthalenedi-carboxylic acid.

33. A transparent polyamide elastomer of the following structure 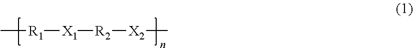
where n represents the number of repeating units in the elastomer, and where R₁ is a microcrystalline hard polyamide segment, or, respectively, hard copolyamide segment, with an enthalpy of fusion in the range from 4 to 40 J/g, and with a melting point of at least 120° C., wherein the number-average molar mass of R₁ is in the range from 750 to 3000 g/mol formed from
a) from 10 to 100 mol % of alkyl-substituted bis(aminocyclohexyl)methane and/or bis(aminocyclo-hexyl)propane and
from 0 to 90 mol % of other cycloaliphatic C6-C36 diamines and/or aliphatic C2-C36 diamines and/or aromatic C6-C36 diamines,
where these concentration values are based on the total amount of diamine in the polyamide segment, and
b) aliphatic C4-C36 dicarboxylic acids and mixtures thereof and
c) if appropriate lactams and/or aminocarboxylic acids having 6-12 carbon atoms,
where R₂ is selected from the group of the following bivalent moieties: linear or branched C2-C5-polyoxyalkylene, selected from the group:
polyoxypropylenediamine with number-average molar weight in the range from 200 to 2500 g/mol, and also copolymers or a mixture of these elements,
wherein R₁ accounts for an amount in the range from 55-80% by weight and R₂ accounts for an amount in the range of 20-45% by weight,
and where X₁ and X₂ are amide bonding systems (CONH),
wherein the transparent polyamide elastomer has an amorphous phase deriving from the segment containing the element R₂, where the glass transition temperature of this phase is at most 20° C.
